(19) United States
(12) Patent Application Publication
(10) Pub. No.: US 2015/0084583 A1
(43) Pub. Date: Mar. 26, 2015

(54) CONTROL OF WIRELESS BATTERY CHARGING

(71) Applicant: NVIDIA Corporation, Santa Clara, CA (US)

(72) Inventors: David Hann Jung, Fremont, CA (US); Robert R. Collins, Morgan Hill, CA (US); Xiaohui Tao, San Jose, CA (US); Arman Toorians, San Jose, CA (US)

(73) Assignee: NVIDIA Corporation, Santa Clara, CA (US)

(21) Appl. No.: 14/035,609

(22) Filed: Sep. 24, 2013

(51) Int. Cl. H02J 7/02

(52) U.S. Cl. CPC H02J 7/025
USPC 320/108; 320/137

(57) ABSTRACT

One embodiment provides a method to store electrical energy in an electronic device, which has a central processing unit (CPU) to provide operating-system and application processing in the device. The method includes controlling, from the CPU of the electronic device, communication sent from the device and received at a wireless charger within communication range of the device. The method further includes computing, in the CPU of the electronic device, a set-point condition for wireless energy flow from the wireless charger to an energy-storage component of the device, and regulating the wireless energy flow based on the set-point condition.

### BACKGROUND

An increasingly attractive technology for use with battery-powered electronic devices is wireless battery charging. This technology offers an elegant alternative to plug-in charging, where power cords and adapters proliferate with the number of devices in use and make one's living or work space appear untidy. In addition, wireless battery charging eliminates the difficulty of locating a compatible power cord or adapter for each electronic device, and may make devices less prone to damage during recharge.

To wirelessly charge a battery in an electronic device, the device typically is placed on or near a wireless charger, which transmits energy to the device in the form of an electromagnetic wave. A portion of the transmitted energy is received by a power-receiver module installed in the electronic device. The power-receiver module typically includes at least one receiver coil. With the electronic device suitably positioned on or near the wireless charger, the receiver coil couples inductively to a transmitter coil in the wireless charger, which carries an alternating electric current. The alternating magnetic flux from the current in the transmitter coil induces an alternating voltage in the receiver coil. Analog componentry in the power-receiver module serves to convert this voltage to an appropriate level for charging the battery of the electronic device.

In the current state of the art, the power-receiver module also includes digital componentry to communicate with and regulate power transfer from the wireless charger. Distributed on one or more chips, the digital componentry may include a mircrocontroller, instruction memory to store supportive software and/or firmware, and at least some data memory.

The inventors herein have identified numerous disadvantages resulting from the use of dedicated digital componentry in the wireless power-receiver module of an electronic device. In brief, the dedicated digital componentry is redundant in a modern, microprocessor-controlled electronic device. Furthermore, the dedicated digital componentry may be limited functionally at design time, and may be difficult or impossible to update in order to accommodate newer batteries or wireless-chargers as they become available.

### BRIEF DESCRIPTION OF THE DRAWINGS

FIG. 1 shows aspects of an example environment for wireless charging of one or more electronic devices in accordance with an embodiment of this disclosure.

FIG. 2 shows aspects of a wireless charger and an electronic device to be charged in accordance with an embodiment of this disclosure.

FIG. 3 shows aspects of a memory module of an electronic device in accordance with an embodiment of this disclosure.

FIG. 4 illustrates a method to store electrical energy in an electronic device in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

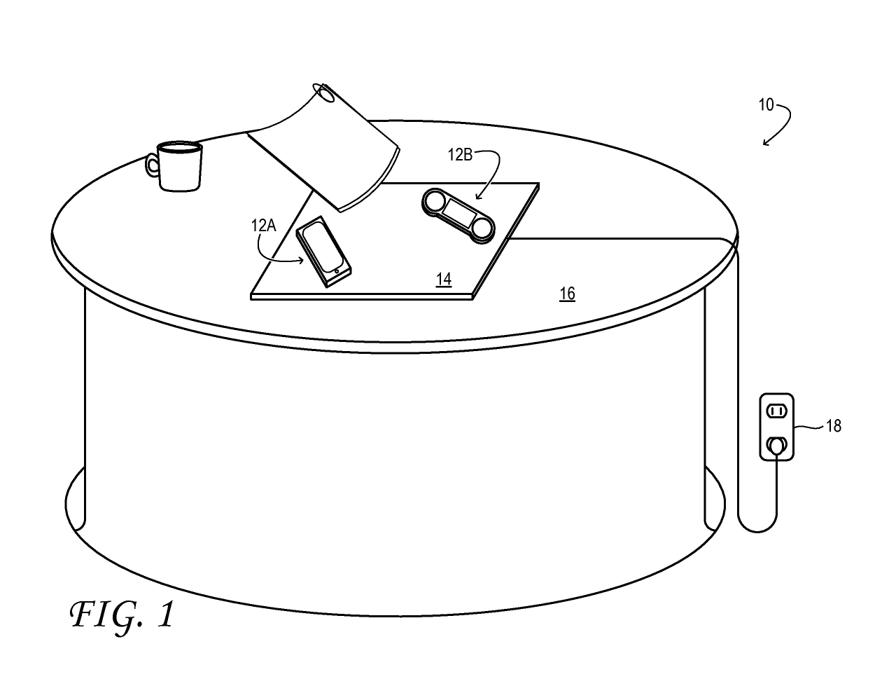

FIG. 1 shows aspects of an example environment 10 for wireless charging of one or more electronic devices. In this environment, electronic devices 12A and 12B are situated on top of a wireless charger 14. The illustrated wireless charger takes the form of a thin pad which may be placed on any horizontal surface, such as tabletop 16. Here, the wireless charger receives power from an electrical outlet 18. In other embodiments, the wireless charger may be built into the tabletop or integrated into any other suitable object or structure—e.g., a docking station for a telephone or tablet computer. As shown in FIG. 1, the environment in which wireless charging is enacted need not be pristine. Indeed, the componentry described herein may be configured to tolerate the presence of various objects and activities around the wireless charger, even in the vicinity of the devices to be charged.

Although FIG. 1 shows two electronic devices 12 arranged on wireless charger 14, this disclosure is equally consistent with the charging of a single electronic device, and with simultaneous or sequential charging of more than two devices. Further, the nature of the electronic device to be charged is not limited in any way; suitable devices may include handheld cellular telephones, handheld game systems, tablet computers, personal digital assistants, power tools, and various other portable, battery-powered devices. Further still, it is not essential that the electronic device to be charged is necessarily a handheld device. This disclosure readily applies, for example, to the wireless charging of an electric vehicle such as a motorized bicycle or automobile. Accordingly, wireless charger 14 may, in some embodiments, be relatively large in size and set on a floor or on the earth. Alternatively, the wireless charger may be arranged vertically and mounted to a wall or post; the device to be charged may be wheeled up to the wireless charger in some examples.

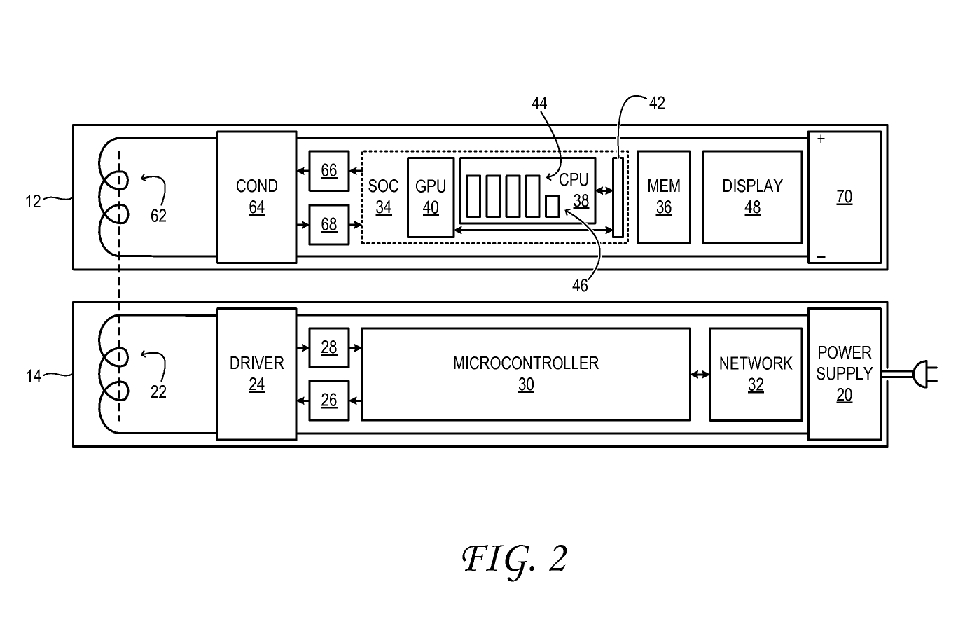

Wireless charging of electronic devices offers a number of advantages over conventional charging via a power cord. As noted above, it reduces the number of power cords and adapters that must be kept on hand for use with the devices. In addition, electronic devices that charge without a power cord may be less prone to damage because there is one less wire that can be accidentally tugged on. In the embodiments described herein, the modality of device charging is not only wireless but effectively contactless. In other words, no direct electrical contact is needed between wireless charger 14 and any electronic device 12. In place of direct electrical contact, power-transmitting componentry in the wireless charger is inductively coupled to power-receiving componentry of the electronic device to be charged. This aspect is described below in further detail, with reference to FIG. 2.

FIG. 2 is a highly schematic elevational view showing aspects of example wireless charger 14, inter alia. The wireless charger includes an internal power supply 20. The internal power supply receives an alternating, line-voltage input and provides one or more output voltages that power the componentry of the wireless charger. In one embodiment, the internal power supply may be a switching power supply; in other embodiments, the internal power supply may include a transformer and full-wave bridge rectifier.

Wireless charger 14 also includes primary or transmitter coil 22 and transmitter coil driver 24. In the embodiment of FIG. 2, an output voltage from internal power supply 20 is fed into the transmitter coil driver. The transmitter coil driver may include a radio-frequency (RF) oscillator configured to apply an alternating voltage of controlled amplitude and frequency to the transmitter coil. In the illustrated embodiment, the amplitude and/or frequency of the voltage is controlled by driver modulator 26. The driver modulator is a communication module configured to vary the amplitude and/or frequency of the voltage applied to the transmitter coil to satisfy the charging requirements of the electronic device being charged, or, as a mode of communication from the wireless charger to the electronic device (vide infra).

Wireless charger 14 also includes a load-modulation sensor 28 operatively coupled to transmitter coil driver 24. The load-modulation sensor is a communication module configured to sense either the current driven through transmitter coil 22 or a suitable surrogate—e.g., the inductive reactance of the transmitter coil, the phase differential of the current with respect to the voltage, etc. In this manner, the load-modulation sensor is configured to sense the rate of power transfer from the wireless charger to the electronic device being charged. In embodiments in which the power-receiving electronic device communicates to the wireless charger via inductive load modulation, the load-modulation sensor may also be used to demodulate such communication.

In the embodiment of FIG. 2, wireless charger 14 includes only one transmitter coil 22 and associated componentry, but this aspect is in no way limiting. In other embodiments, the wireless charger may be composed of an array of horizontal cells, with a transmitter coil disposed in each of the cells.

Continuing in FIG. 2, wireless charger 14 also includes a microcontroller 30 operatively coupled to driver modulator 26 and to load-modulation sensor 28. In particular, the microcontroller is configured to control the voltage modulation applied by the driver modulator and to receive the output of the load-modulation sensor. The microcontroller is also operatively coupled to network component 32, which may support any form of wired or wireless data exchange with any available data network, including the internet. The network component may be an Ethernet or Wi-Fi module, for example.

FIG. 2 also shows aspects of electronic device 12—a device configured to wirelessly receive power from wireless charger 14. Although the electronic device and wireless charger appear in FIG. 2 to be of similar dimensions, this aspect is by no means necessary. Rather, this disclosure is equally consistent with embodiments in which the wireless charger is considerably larger than the electronic device or devices to be charged. This disclosure is also consistent with embodiments in which the electronic device is arranged over one or more cells of the wireless charger, with additional cells remaining vacant, or being used to charge other electronic devices.

In the embodiment of FIG. 2, electronic device 12 includes a system-on-a-chip (SOC) 34 operatively coupled to a memory module 36 and to various other componentry. The SOC includes central-processing unit (CPU) 38 integrated together with graphics-processing unit (GPU) 40 and memory controller 42. The SOC may further include additional, integrated system components, such as a northbridge and a southbridge. In the illustrated embodiment, the CPU is a multicore unit configured for simultaneous execution of a plurality of software threads. The CPU may be configured to provide operating-system (OS) and application processing in the electronic device. To this end, the CPU may include four main processing cores 44, as shown, with cache memory associated with each core. The CPU may also include an additional, low-power core 46 to accomplish various background tasks at reduced power consumption.

In the embodiment of FIG. 2, SOC 34 is operatively coupled to a display component 48, which in some examples may be a touch-screen display. The SOC may be further coupled to various other input-output (10) componentry—a Wi-Fi radio, Bluetooth radio, cellular radio, camera, and/or global-positioning system (GPS) receiver, for example. In these and other embodiments, the electronic device may include various other components or modules known in the ecosystem of mobile devices. Such modules may include a near-field communications (NFC) module, a gyroscopic orientation sensor, an accelerometer, and/or a temperature sensor.

Continuing in FIG. 2, memory module 36 is configured to store various software and firmware aspects of electronic device 12 for execution in SOC 34. Physically, the memory module consists of an array of machine-readable, electronic memory components, which may include volatile memory, non-volatile memory, random-access memory (RAM), and read-only memory (ROM), for example. Such memory is accessed by the SOC componentry through integrated memory controller 42. The physical memory of the memory module may be partitioned logically into various sub-modules that instantiate the operating system (OS) of the electronic device, one or more applications, and various data structures.

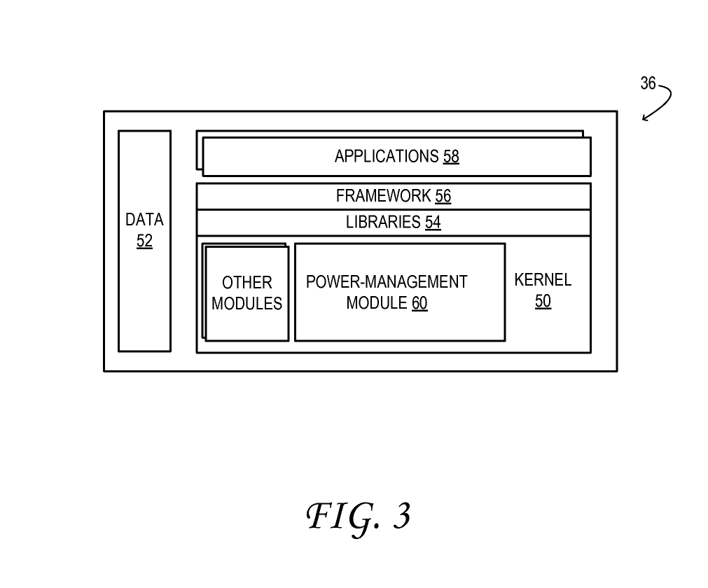

FIG. 3 shows aspects of memory module 36 in somewhat greater detail. In the embodiment of FIG. 3, the OS instantiated in the memory module includes a kernel 50, which runs on CPU 38, with access to data model 52; the kernel commands the various operations of SOC 34 at a low level. Running on top of the OS kernel are one or more libraries 54, which in turn support application framework 56. Example libraries may include a surface-manager library, a media framework library, a web-kit library, a structured query language (SQL) library, a secure shell (SSL) library, and/or a C-language library. The application framework is configured to support the various end-use applications 58 of electronic device 12, such as browsers, games, navigation or telephony applications. To this end, the application framework may include a window manager, an activity manager, a resource manager, a notification manager and/or a location manager, for example. In some embodiments, the kernel may also support a core run-time library and/or virtual machine. Accordingly, the OS instantiated in memory module 36 may, in one non-limiting embodiment, be an Android® operating system.

In one embodiment, kernel 50 may be a Linux® kernel. It may include various hardware driver modules: a display driver, a camera driver, a Bluetooth driver, a flash-memory driver, a binder driver, a universal serial bus (USB) driver, a keypad driver, a Wi-Fi driver, and one or more audio drivers, for example. In the illustrated embodiment, kernel 50 also includes a power-management module 60.

Returning now to FIG. 2, electronic device 12 includes a secondary or receiver coil 62. In the expected usage scenario, electronic device 12, when it requires charging, is positioned on the upper surface of wireless charger 14 such that receiver coil 62 of the electronic device inductively couples to transmitter coil 22 of the wireless charger. Accordingly, the alternating current flowing through the transmitter coil induces an alternating voltage in the receiver coil. In this manner, the receiver coil is configured to receive electrical energy through inductive coupling to the transmitter coil of the wireless charger.

In the illustrated embodiment, this alternating voltage is applied to conditioning module 64, where it is conditioned for use in the electronic device. The conditioning module may rectify the alternating voltage from the receiver coil into a direct voltage. In some examples, the conditioning module may enact high-frequency switching to drive a plurality of direct voltages—e.g., +3.3 volts, −3.3 volts, etc. In some embodiments, the conditioning module may include load-regulating functionality to control how much current is permitted to flow through the receiver coil in response to the alternating voltage induced therein. Such functionality may be embodied as one or more electronically controlled switches or voltage controlled resistances or reactances. In some embodiments, the conditioning module may impart an adjustable capacitance across the receiver coil; the adjustable capacitance may be varied so as to change the phase differential of the current with respect to the induced voltage. Thus, the conditioning module may, in various ways, control the extent of loading of the receiver coil, which determines how much power is extracted from the receiver coil and delivered to downstream componentry of the electronic device.

In some embodiments, the extent of loading of receiver coil 62 may be used as a mode of communication from electronic device 12 to wireless charger 14. To this end, the electronic device of FIG. 2 includes load modulator 66, a communication module operatively coupled to conditioning module 64 and configured to send communication to the wireless charger in the form of a modulated inductive load. In turn, CPU 38 is operatively coupled to the load modulator and configured to control the communication sent therefrom. The load modulator is configured to send the communication by modulating the inductive load, which is sensed at load modulation sensor 28 of the wireless charger. Operationally, the load modulator of the illustrated embodiment is configured to provide input to conditioning module 64, and the conditioning module is configured to modulate the extent of loading of the receiver coil based on the input from the load modulator.

In embodiments in which wireless charger 14 includes a driver modulator 26 configured to send communications to electronic device 12, the electronic device may include a signal demodulator 68—a communication module configured to demodulate the communication signal embedded in the alternating magnetic flux from transmitter coil 22 (which appears in the form of an induced voltage modulation in receiver coil 62). In this manner, the electronic device may be configured also to receive communication from the wireless charger, as well as to send communication.

In the embodiments emphasized above, communications between wireless charger 14 and the electronic device 12 are exchanged by modulating the magnetic flux shared between transmitter coil 22 of the wireless charger and receiver coil 62 of the electronic device. Although this is an efficient use of system hardware, it does not preclude other modes of communication. For instance, the various other communication modules may be configured to use infrared or Bluetooth communications, or indeed any other suitable mode of data exchange.

In one particular embodiment, the CPU processor core operatively coupled to load modulator 66 and/or signal demodulator 68 may also be configured to provide at least some operating-system and application processing in the electronic device. Machine-readable memory associatively coupled to this processor core may hold instructions that direct the processor core to provide such operating-system and application processing in the electronic device, and to enact various other wireless charging functions as described hereinafter. In brief, the instructions may direct the processor core to compute a set-point condition for wireless energy flow from the wireless charger to the energy-storage component, to regulate the wireless energy flow based on the set-point condition, to control the communication from the communication component, etc. In one embodiment, this processor core may be a low-power processor core—e.g., a companion processor core in a CPU that further includes one or more higher-power, higher-performance processor cores. In this embodiment, the one or more higher-power, higher-performance processor cores may not be configured to participate in computing the set-point condition or in regulating the wireless energy flow. This approach is advantageous because it enables the electronic device to use less power while charging, resulting in overall faster charging and charging from initial states of deeper discharge.

In the embodiment of FIG. 2, the various componentry of electronic device 12 is powered directly or indirectly by a rechargeable energy-storage component 70. The energy-storage component may include one or more secondary cells—e.g., lithium-ion cells, metal hydride cells, or other rechargeable battery cells. In an alternative embodiment, the energy storage component may include one or more high-charge capacitors—e.g., supercapacitors, ultracapacitors, etc. In the expected use scenarios, at least a portion of the energy received into electronic device 12 from wireless charger 14 is stored in the energy-storage component for later use.

No aspect of the drawings should be interpreted in a limiting sense, for numerous other configurations lay fully within the spirit and scope of this disclosure. For example, while FIG. 2 shows CPU 38 integrated into SOC 34, this aspect is by no means necessary. The disclosed approach is equally applicable in traditional, stand-alone CPUs.

The configurations described above enable various methods to store electrical energy in an electronic device. Accordingly, some such methods are now described, by way of example, with continued reference to the above configurations. It will be understood, however, that the methods here described, and others within the scope of this disclosure, may be enabled by different configurations as well. Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

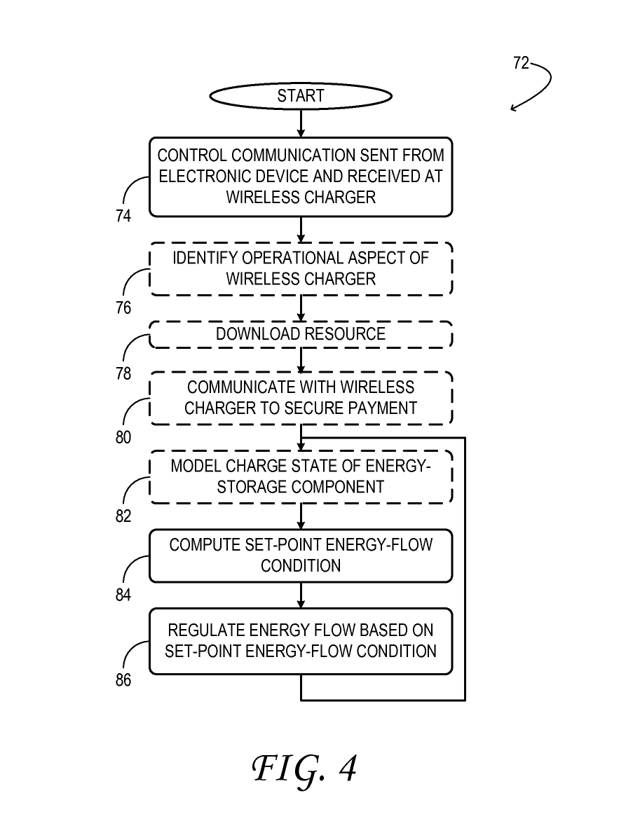

FIG. 4 illustrates an example method 72 to be enacted within an electronic device, such as electronic device 12, to store electrical energy within the device. At 74, the CPU of the electronic device asserts or maintains control of the communication sent from the device and received at a wireless charger within communication range of the device. Such communication may be directed to a variety of useful purposes. For example, some wireless charging protocols may include a so-called ‘ping’ phase in which the wireless charger broadcasts a signal to announce itself, and then listens for a reply from the electronic device to be charged. If a suitably positioned electronic device is present and in need of charging, that device may transmit an unambiguous reply to the ping. Only after the wireless charger receives such a reply does it begin to deliver power. This protocol enables the wireless charger to recognize compatible power transmitters.

At optional step 76 of method 72, an operational aspect of the wireless charger is identified by the electronic device. The identified aspect may differ in the different embodiments of this disclosure. It may include the power rating, power transmission frequency, duty-cycle, and/or size of the wireless charger, for example. In these and other embodiments, the identified aspect may include the maker and/or model number of the wireless charger. The aspect may be identified via any suitable exchange of data between the electronic device and the wireless charger using the various communication modules described above.

At optional step 78 of method 72, a resource related to electronic-device charging may be downloaded from an external server via a network module of the electronic device. In some embodiments, the resource may take the form of a dedicated application (i.e., ‘app’) or widget. At least two different resource embodiments are envisaged in this disclosure. In one embodiment, the resource is configured to enable the electronic device to be charged at a particular wireless charger or family of wireless chargers, which may differ from the wireless charger that the electronic device was originally intended to work with. In a second embodiment, the resource may be configured to enable a particular energy-storage component in the electronic device to be charged. This component, for example, may be a replacement battery of different electrical characteristics (capacity, impedance, etc.) than the battery originally intended for use with the electronic device. In a related embodiment, the energy-storage component supported by the downloaded resource may not be a replacement per se, but the result of a midstream redesign in production. Naturally, the resource embodiments described herein may be used together. For instance, a given resource may enable a particular energy-storage component in the electronic device to be charged using a particular wireless charger.

Continuing in FIG. 4, it will be noted that ping-and-reply is only one example of the data that may be communicated between the electronic device and the wireless charger. In optional step 80 of method 72, these systems communicate with each other in order to secure payment in exchange for the wireless energy flow. In some scenarios, a wireless charger may be installed in a hotel room or an airport departure gate, for example. A traveler wishing to charge his or her device may set the device down on the wireless charger and be prompted, via a user interface of the device, to authorize payment for the wireless charging service. The wireless charger may require receipt of a specially formulated communication (i.e., a key) from the device before it delivers power to the device. In some embodiments, the details of the payment may be negotiated from a browser window on the electronic device, which accesses a web service of the wireless-charger provider. This embodiment further underscores the advantage of having communications between the electronic device and the wireless charger controlled by the CPU of the device.

At 82 the charge state of the energy-storage component is modeled. Such modeling may be used in order to compute the optimal voltage or current to be applied to the energy storage component to return it to a fully charged state without causing damage. In one embodiment, the modeling of the charge state may be based on a history of charge and discharge activity in the electronic device. As such the modeling effort may require storage of a significant amount of data, and access to that data during the charging process. Accordingly, it may be advantageous for the modeling to be enacted in a CPU, rather than a microcontroller of limited processing power and access to memory.

At 84 a set-point condition for wireless energy flow from the wireless charger to an energy-storage component of electronic device is computed in the CPU of the electronic device. In one, non-limiting embodiment, the computed set-point condition may be as simple as an ON or OFF condition—e.g., ON indicating that wireless energy flow is desired, OFF indicating that wireless energy flow is not desired. In other embodiments, the computed set-point condition may reflect a desired voltage or current to be applied across the energy-storage component, or a desired power to be received from the wireless charger.

At 86 the wireless energy flow from the wireless charger to the energy storage component is regulated based on the set-point condition. As used herein, the term ‘regulation’ may encompass up-regulation (increasing the rate of energy flow) and/or down-regulation (decreasing the rate of energy flow) as needed to arrive at agreement with the set-point condition. In the various embodiments here contemplated, the CPU itself may be configured to compute the set-point condition for wireless energy flow from the wireless charger to the energy-storage component and to regulate the wireless energy flow based on the set-point condition.

At 86, the amount of power transmitted and/or received (or a suitable surrogate, such as the current drawn though the transmitter coil) may be analyzed via one or more algorithms executed from the CPU. Such algorithms may be used to determine whether a conductive, foreign object (coins, keys, paper clips, foil, etc.) has been inadvertently placed between the transmitter and receiver coils.

The skilled reader will note that in the context of distinguishing a wirelessly chargeable device from adventitious conductive material, it is a great benefit for device communications to be controlled by a sophisticated CPU, rather than a primitive microcontroller. The processing power of the CPU and its associated ecosystem of 10 componentry can enable a more complex, unambiguous reply to be formulated, which is received more reliably by the wireless charger, even in relatively noisy environments and/or various temperatures.

In one embodiment, regulating the wireless energy flow may include controlling an impedance between a receiver coil of the electronic device and the energy-storage component. Thus, the mode of regulation may be internal to the electronic device being charged, and need not involve the cooperation of the charging station. In another embodiment, regulating the wireless energy flow may include sending the wireless charger a request to adjust the wireless energy flow. Thus, the mode of regulation may be at least partly external to the electronic device being charged, requiring the cooperation of the wireless charger. In general, any aspect of the wireless energy flow may be adjusted in this manner—e.g., the amplitude or frequency of the alternating current in the transmitter coil of the wireless charger, or the duty cycle.

No aspect of the foregoing method should be understood in a limiting sense, for numerous variations and extensions are contemplated as well. It will be noted, for example, that the various aspects of method 72—e.g., controlling, computing, and regulating—may be controlled by one or more software programs, and that the above method may also include the act of updating or upgrading the software programs to improve performance, extend functionality, etc. In embodiments in which the electronic device to be charged identifies some aspect of the wireless charger (optional step 76), that aspect may be used to control or influence one or more of the controlling, computing, and regulating actions described hereinabove. In other words, such actions may be modified or adjusted in dependence on the operational aspect identified above. In these and other embodiments, one or more of the controlling, computing, and regulating may be elements of a standard that the electronic device adheres to in the course of accepting power and exchanging communication with the wireless charger. Because the electronic device charging is controlled from the CPU, it is possible for a plurality of standards to be supported by the electronic device. Thus, the standard adhered to may be selected from among a plurality of extant standards, depending on the operational aspect identified.

It will be understood that the configurations and/or approaches described herein are exemplary in nature, and that these specific embodiments or examples are not to be considered in a limiting sense, because numerous variations are possible. The subject matter of the present disclosure includes all novel and non-obvious combinations and sub-combinations of the various processes, systems and configurations, and other features, functions, acts, and/or properties disclosed herein, as well as any and all equivalents thereof.

1. Enacted in an electronic device having a central processing unit (CPU), a method to store electrical energy in the device, the CPU providing operating-system and application processing in the device, the method comprising:
from the CPU of the electronic device, controlling communication sent from the device and received at a wireless charger within communication range of the device;
in the CPU of the electronic device, computing a set-point condition for wireless energy flow from the wireless charger to an energy-storage component of the device; and
regulating the wireless energy flow based on the set-point condition.

2. The method of claim 1 wherein regulating the wireless energy flow includes controlling an impedance between a receiver coil of the electronic device and the energy-storage component.

3. The method of claim 1 wherein regulating the wireless energy flow includes sending the wireless charger a request to adjust the wireless energy flow.

4. The method of claim 1 further comprising downloading a resource that enables the electronic device to be charged at the wireless charger.

5. The method of claim 1 wherein the energy-storage component is a replacement component, the method further comprising downloading a resource that enables the energy-storage component to be charged in the electronic device.

6. The method of claim 1 further comprising enacting one or more algorithms to enable the wireless charger to distinguish whether conductive material is inadvertently placed between the wireless charger and the device being charged.

7. The method of claim 1 further comprising communicating with the wireless charger to secure payment in exchange for the wireless energy flow.

8. The method of claim 1 wherein one or more of the controlling, computing, and regulating are controlled by software, the method further comprising updating the software.

9. The method of claim 1 further comprising identifying an operational aspect of the wireless charger, wherein one or more of the controlling, computing, and regulating are adjusted in dependence on the operational aspect.

10. The method of claim 9 wherein the one or more of the controlling, computing, and regulating conforms to an applied standard, and wherein the applied standard is selected from among a plurality of extant standards depending on the operational aspect identified.

11. The method of claim 1 further comprising modeling a charge state of the energy-storage component.

12. The method of claim 11 wherein modeling the charge state is based on a history of charge and discharge activity in the electronic device.

13. An electronic device comprising:
an energy-storage component;
a receiver coil configured to receive electrical energy through inductive coupling to a transmitter coil of a wireless charger;
a central processing unit (CPU) providing operating-system and application processing in the electronic device, the CPU configured to compute a set-point condition for wireless energy flow from the wireless charger to the energy-storage component and to regulate the wireless energy flow based on the set-point condition.

14. The electronic device of claim 13 further comprising a communication module operatively coupled to the CPU and configured to send communication to the wireless charger, wherein the CPU is further configured to control the communication sent by the communication module.

15. The electronic device of claim 14 wherein the communication module is configured to send the communication by modulating an inductive load sensed at the wireless charger.

16. The electronic device of claim 14 wherein the communication sent by the communication module is a first communication, and wherein the communication module is further configured to receive a second communication from the wireless charger in a form of an induced voltage in the receiver coil.

17. A central processing unit (CPU) for a mobile electronic device, the CPU comprising:
a processor core configured to provide at least some operating-system and application processing in the electronic device, the processor core operatively coupled to a communication module configured to send communication to a wireless charger within communication range of the electronic device; and
machine-readable memory associatively coupled to the processor core, the memory holding instructions that direct the processor core to provide the at least some operating-system and application processing in the electronic device, to compute a set-point condition for wireless energy flow from the wireless charger to the energy-storage component, to regulate the wireless energy flow based on the set-point condition, and to control the communication from the communication module.

18. The CPU of claim 17 wherein the processor core is a low-power processor core, and wherein the CPU further comprises one or more higher-power, higher-performance processor cores.

19. The CPU of claim 18 wherein the one or more higher-power, higher-performance processor cores are not configured to participate in computing the set-point condition or in regulating the wireless energy flow.

20. The CPU of claim 17 wherein the CPU is integrated into a system-on-a-chip that further includes a northbridge, southbridge, and memory controller.
